(19) United States
(12) Patent Application Publication
(10) Pub. No.: US 2019/0045245 A1
(43) Pub. Date: Feb. 7, 2019

(54) VIDEO DISPLAY SYSTEM

(71) Applicant: SHARP KABUSHIKI KAISHA, Sakai City, Osaka (JP)

(72) Inventor: Takaji NUMAO, Sakai City (JP)

(73) Assignee: Sharp Kabushiki Kaisha, Sakai City, Osaka (JP)

(21) Appl. No.: 15/759,681

(22) PCT Filed: Aug. 9, 2016
(86) PCT No.: PCT/JP2016/073401

§ 371 Date: Mar. 13, 2018

(30) Foreign Application Priority Data
Sep. 15, 2015 (JP) 2015-182032

(51) Int. Cl. H04N 21/2343; H04N 21/485; H04N 21/258; H04N 21/81; H04N 21/4223; H04N 21/442

(52) U.S. Cl. CPC H04N 21/234363; H04N 21/4854; H04N 21/44218; H04N 21/812; H04N 21/4223; H04N 21/25891

(57) ABSTRACT

The video display system includes: a display device configured to display a video; and a server installed external to the display device. The SoC in the display device transmits, to the server, desirable image quality information inputted by the user for each type of video. The server stores the transmitted image quality information for each type of video for each user. The SoC obtains information related to a type of a video to be displayed and transmits, to the server, the obtained information related to the type of the video to be displayed. The SoC also obtains, from the server, image quality information in accordance with the type of the video to be displayed and adjusts image quality of the video to be displayed based on the obtained image quality information.

### TECHNICAL FIELD

The present application hereby claims priority to Japanese Patent Application, Tokugan, No. 2015-182032 filed Sep. 15, 2015, the entire contents of which are hereby incorporated herein by reference.

The following disclosure relates to video display systems.

### BACKGROUND ART

Some conventional display devices that produce displays from received television broadcast have a function that allows users to adjust image quality. Patent Literature 1 discloses a television receiver that displays a plurality of moving image samples having been previously subjected to different image quality adjustments for the user to choose from and adjusts the image quality of images to be displayed on the basis of one of the moving image samples chosen by the user.

### CITATION LIST

### Patent Literature

Patent Literature 1: Japanese Unexamined Patent Application Publication, Tokukai, No. 2001-119644

### SUMMARY OF INVENTION

### Technical Problem

Many users want to adjust the image quality of television programs to match the types of the programs, for example, such that they can view cartoon films in vivid colors. The approach taken by Patent Literature 1 inevitably requires the user to adjust the image quality of a program in accordance with its type every time, which is troublesome and undesirable.

In view of this problem, it is an objective of the following disclosure to provide a technology that enables image quality to be readily adjusted in accordance with video types and users' preferences.

### Solution to Problem

The present invention, in an embodiment thereof, is directed to a video display system including: a display device configured to display a video; and a server installed external to the display device, wherein the display device includes: an input unit configured to enable a user to input desirable image quality information for each type of video; a video type obtaining unit configured to obtain information related to a type of a video to be displayed; a transmission unit configured to transmit the image quality information inputted through the input unit to the server and also to transmit, to the server, the information obtained by the video type obtaining unit in relation to the type of the video to be displayed while the video is being displayed; an image quality information obtaining unit configured to obtain, from the server, image quality information in accordance with the type of the video to be displayed; and an image quality adjusting unit configured to adjust image quality of the video to be displayed based on the image quality information obtained by the image quality information obtaining unit, and the server stores the image quality information transmitted from the transmission unit for each type of video for each user.

### Advantageous Effects of Invention

The disclosure of the present embodiment enables automatic image quality adjustment in accordance with video types and users' preferences for each user.

### BRIEF DESCRIPTION OF DRAWINGS

FIG. 1 is a block diagram of a configuration of a video display system in accordance with a first embodiment.

FIG. 2 is a flow chart depicting a flow of a process performed by the video display system of the first embodiment.

FIG. 3 is an illustration of a remote control for use in manually operating screen displays on a display device.

FIG. 4 is a diagram showing an example set of information stored in a cloud server.

FIG. 5 is a diagram representing a relationship between a service provider that provides automatic image quality adjustment service and advertisers.

FIG. 6 is an illustration of an example advertisement displayed in response to activation of a display device until a program is displayed.

FIG. 7 is a block diagram of a configuration of a video display system in accordance with a second embodiment.

FIG. 8 is a diagram showing the types of ad information displayed on a display device and the flow of ad delivery fees in accordance with the second embodiment.

FIG. 9 is a block diagram of a configuration of a video display system in accordance with a third embodiment.

FIG. 10 is a diagram showing the flow of, for example, ad viewing information, ad delivery fees, and information fees in accordance with the third embodiment.

### DESCRIPTION OF EMBODIMENTS

The present invention, in an embodiment thereof, is directed to a video display system including: a display device configured to display a video; and a server installed external to the display device, wherein the display device includes: an input unit configured to enable a user to input desirable image quality information for each type of video; a video type obtaining unit configured to obtain information related to a type of a video to be displayed; a transmission unit configured to transmit the image quality information inputted through the input unit to the server and also to transmit, to the server, the information obtained by the video type obtaining unit in relation to the type of the video to be displayed while the video is being displayed; an image quality information obtaining unit configured to obtain, from the server, image quality information in accordance with the type of the video to be displayed; and an image quality adjusting unit configured to adjust image quality of the video to be displayed based on the image quality information obtained by the image quality information obtaining unit, and the server stores the image quality information transmitted from the transmission unit for each type of video for each user (first aspect).

In the first aspect, once the user inputs image quality information for each type of video, image quality is adjusted automatically in accordance with the type of video and the user's preferences.

The video display system of the first aspect may be configured such that: the display device further includes a display control unit configured to cause a display screen to be displayed on which the user is asked whether or not the user agrees to use image quality adjustment service by which image quality of a video is adjusted in accordance with a type of the video and to have ad information displayed: and the display control unit causes the ad information to be displayed if the user has agreed to use the image quality adjustment service and to have the ad information displayed (second aspect).

In the second aspect, the user of the image quality adjustment service is asked to agree to have ad information displayed. The display device can therefore display ad information under the agreement with the user. In addition, while a limited number of users would agree if only asked for permission to display ad information, many of them will agree if the ad display is offered in combination with the image quality adjustment service. The service provider, providing the image quality adjustment service, can hence collect more ad delivery fees from advertisers.

The video display system of the second aspect may be configured such that: the display control unit, if the user has agreed to use the image quality adjustment service, causes a screen to be displayed on which the user can input user attribute information; the transmission unit, if the user has inputted user attribute information through the input unit, transmits the user attribute information to the server; the server stores ad information of each user in accordance with the user attribute information transmitted from the transmission unit; and the display control unit obtains ad information in accordance with the user attribute information from the server and causes the ad information to be displayed upon activation of the display device until a video is displayed, upon activation of the display device until a video fed from an external device connected to the display device is displayed, and/or during switching of videos to be displayed (third aspect).

In the third aspect, each user has ad information displayed on his/her display device in accordance with his/her user attribute information. This arrangement enables an effective advertisement display that is interesting to the user. In addition, the ad information is displayed upon activation of the display device until a video is displayed, upon activation of the display device until a video fed from an external device connected to the display device is displayed, and/or during switching of videos to be displayed. This arrangement enables the ad information to be displayed until a video such as a program is displayed.

The video display system of the third aspect may be configured such that the display control unit obtains ad information of an advertiser from the server in accordance with the user attribute information and causes the ad information obtained from the server to be displayed in a part of an ad broadcasting time slot for that same advertiser in a television program (fourth aspect).

In the fourth aspect, the ad information obtained from the server is displayed in an ad broadcasting time slot in a television program. The user would therefore comfortably view the ad information. In addition, the ad information is displayed in accordance with the user attribute information. This arrangement enables a more effective advertisement display than ad broadcasting aimed at general audiences.

The video display system of any one of the first to fourth aspects may be configured such that the display device further includes: an image capture unit configured to capture an image of an object before the display device; and an image processing unit configured to perform a face recognition process on the image captured by the image capture unit, so as to obtain information as to whether or not the user is viewing ad broadcasting (fifth aspect).

In the fifth aspect, information is available as to whether or not the user is viewing ad broadcasting. Advertisers and information search companies can therefore obtain information as to whether or not users are viewing ad broadcasting so that they can work on making more effective ad broadcasting. Additionally, the service provider providing the image quality adjustment service can sell the information as to whether or not users are viewing ad broadcasting to advertisers and information search companies to collect information fees.

### EMBODIMENTS

The following will describe embodiments of the present invention in detail in reference to drawings. Identical or equivalent members will be denoted by the same reference signs in the drawings, and description thereof is not repeated. For clarity purposes, the drawings to which reference will be made in the following description may show structures in a simplified or schematic form or omit some structural members. The relative dimensions of the structural members as shown in the drawings may not represent the actual relative dimensions thereof.

### First Embodiment

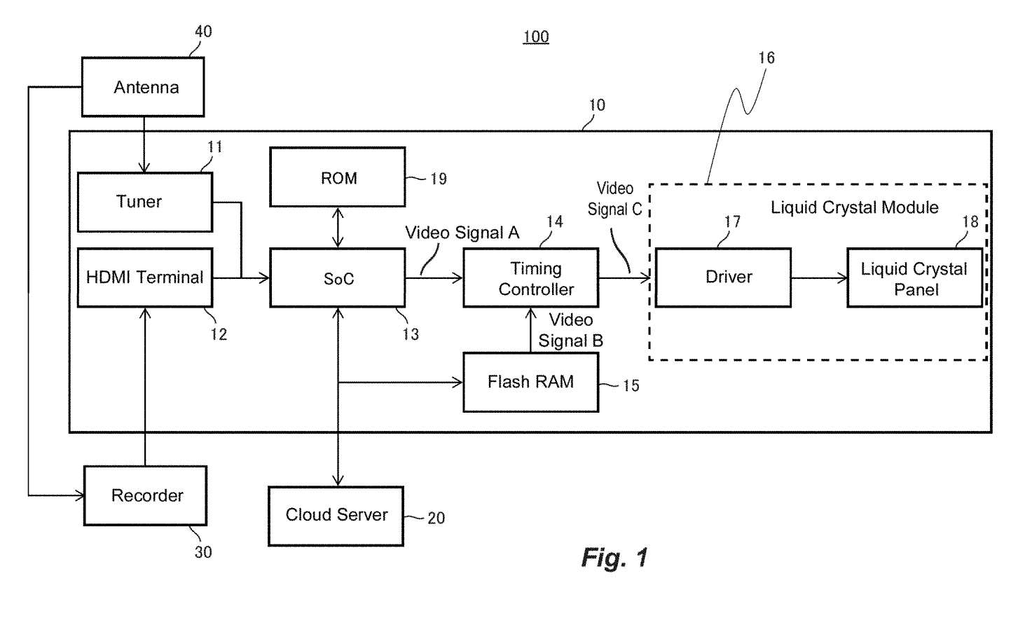

FIG. 1 is a block diagram of a configuration of a video display system 100 in accordance with a first embodiment. The video display system 100 of the first embodiment includes a display device 10 and a cloud server 20. This video display system 100 further includes a recorder 30 and an antenna 40.

The display device 10 is capable of displaying videos and may be, for example, a liquid crystal television. The display device 10 is by no means limited to a liquid crystal television and may alternatively be a plasma television, an organic EL television, an MEMS (micro electromechanical system) television, or a like television.

The display device 10 includes a tuner 11, an HDMI (high definition multimedia interface)® terminal 12, a SoC (system on chip) 13, a timing controller 14, a flash RAM 15, and a liquid crystal module 16. The liquid crystal module 16 includes a driver 17 and a liquid crystal panel 18.

The tuner 11 receives broadcasting signals for television broadcasting, such as terrestrial, satellite, and cable television broadcasting, via the antenna 40 connected to the display device 10 and picks up a broadcasting signal of a desired frequency from the received broadcasting signals. The tuner 11 further picks up video and audio signals from that broadcasting signal of a desired frequency and feeds the video and audio signals to the SoC 13.

The recorder 30, provided externally, has a built-in tuner for receiving broadcasting signals for television broadcasting, such as terrestrial, satellite, and cable television broadcasting, via the antenna 40 and is capable of recording video and audio signals for desired programs. The recorder 30 has an HDMI terminal connected to the HDMI terminal 12 of the display device 10 via an HDMI cable. The recorder 30 is, for example, a Blu-ray disc recorder.

When the video signal recorded in the recorder 30 is to be reproduced to display a video on the display device 10, the video and audio signals supplied from the recorder 30 via the HDMI terminal 12 are fed to the SoC 13.

The display device 10 and the recorder 30 are not necessarily connected via HDMI terminals.

The SoC 13 generates a video signal A for producing a display on the display device 10 on the basis of the video signal supplied from the tuner 11 or the video signal supplied from the recorder 30 via the HDMI terminal 12. The SoC 13 functions as: a video type obtaining unit for obtaining information related to the type of a video to be displayed; a transmission unit for transmitting to the cloud server 20 image quality information inputted by the user and also for transmitting to the cloud server 20 information obtained in relation to the type of a video while the video is being displayed; an image quality information obtaining unit for obtaining image quality information associated with a type of video from the cloud server 20; an image quality adjusting unit for adjusting the image quality of a video to be displayed on the basis of the image quality information obtained: and a display control unit for controlling a display screen.

The flash RAM 15 contains a predetermined video signal B for producing a display on the display device 10. The video signal B is a signal for producing a video display on the display device 10 upon activation of the display device 10, until the video signal A is supplied from the SoC 13 to the timing controller 14.

The timing controller 14 outputs either the video signal A supplied from the SoC 13 or the video signal B stored in the flash RAM 15 as a video signal C to the liquid crystal module 16. The timing controller 14 and the SoC 13 serve as a display control unit.

The process carried out by the SoC 13 may be performed by the timing controller 14. In such a case, the timing controller 14 functions as: a video type obtaining unit for obtaining information related to the type of a video to be displayed; a transmission unit for transmitting to the cloud server 20 image quality information inputted by the user and also for transmitting to the cloud server 20 information obtained in relation to the type of a video while the video is being displayed; an image quality information obtaining unit for obtaining image quality information associated with a type of video from the cloud server 20; and an image quality adjusting unit for adjusting the image quality of a video to be displayed on the basis of the image quality information obtained.

The driver 17 in the liquid crystal module 16 includes a gate driver and a source driver. The driver 17 drives the liquid crystal panel 18 to display a video on the basis of the video signal C supplied from the timing controller 14.

The display device 10 can connect to the cloud server 20 over the Internet. The cloud server 20, as will be described later in detail, stores sets of image quality information and ad information configured in correspondence to types of videos for each user.

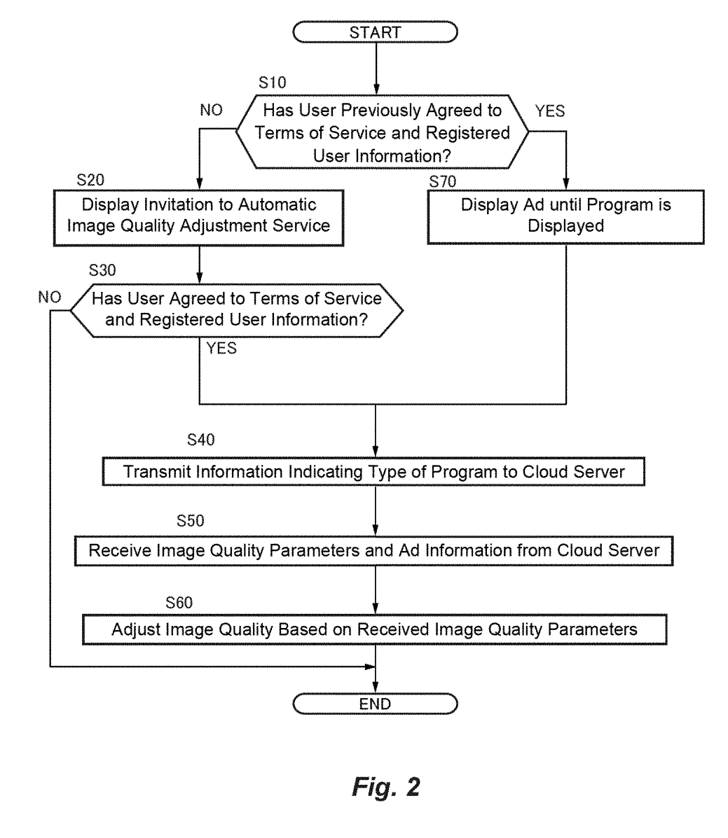

FIG. 2 is a flow chart depicting a flow of a process performed by the video display system 100 of the first embodiment. As the power supply for the display device 10 is turned on, the display device 10 starts performing the process at step S10.

In step S10, the timing controller 14 or the SoC 13 determines whether or not the user has previously agreed to the terms of service (details will be given later) and registered his/her user information. Upon determining that the user has not agreed to the terms of service and registered his/her user information yet, the process proceeds to step S20. If the display device 10 is turned on for the first time after being purchased by the user, step S20 is subsequently performed because the user is yet to agree to the terms of service and register his/her user information.

In step S20, the liquid crystal panel 18 displays an invitation to automatic image quality adjustment service (favorite image quality delivering service). The automatic image quality adjustment service will be described later in detail.

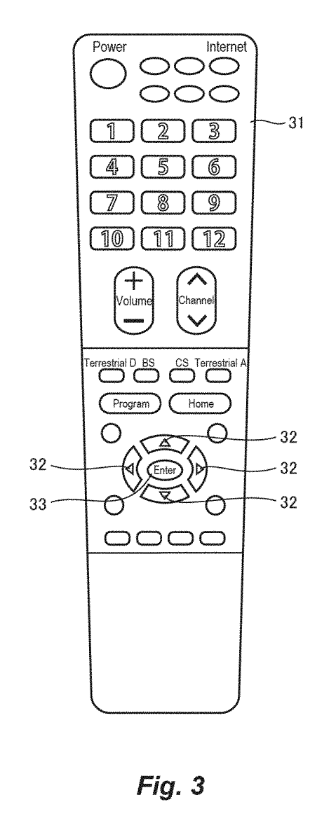

In the present embodiment, the flash RAM 15 contains a video signal (video signal B) for an invitation to the automatic image quality adjustment service by which each user can make image quality settings for each video type (program category). A displayed video invitation to the automatic image quality adjustment service includes a text message such as “Subscribe to our automatic image quality adjustment service, and we'll adjust image quality to suit your taste.” A video is also displayed that enables the user to select either “Agree to use the service” or “Not now” by manually operating a remote control 31 (see FIG. 3).

The user can select whether to use the automatic image quality adjustment service, by manually operating the remote control 31. If the user selects to use the automatic image quality adjustment service, the timing controller 14 or the SoC 13 connects to the cloud server 20 to display on the liquid crystal panel 18 a screen prompting the user to agree to the terms of service and register his/her user information.

The user can select whether to agree to the terms of service and register user information by operating the remote control 31. The terms of service are, for example, a set of conditions to use the automatic image quality adjustment service and include a provision that the user agrees to have ads displayed on the display device 10. Therefore, if the user agrees to the terms of service, the service provider is permitted to display ads on the display device 10.

The user information includes image quality information configurable by the user in relation to video types (program categories). Examples of the video types (program categories) include cartoon film, drama, movie, and documentary. The user can make desirable image quality settings for each video type to his/her own liking, for example, such that cartoons and documentaries are reproduced in vivid colors and natural colors respectively.

The image quality settings can be made by the user operating the remote control 31. For example, the display device 10 displays a screen where image quality can be adjusted for each type of video. This image quality adjusting screen may be designed either to allow the user to intuitively adjust image quality by giving options such as “vivid colors” and “natural colors” or to allow the user to freely alter parameters such as brightness, hue, contrast, sharpness, on/off of a FRC (frame rate converter), and video interpolation methods in an upconverter.

The user information includes information related to the user's attributes (hereinafter, “user attribute information”). Examples of user attribute information include age, gender, address, and hobbies.

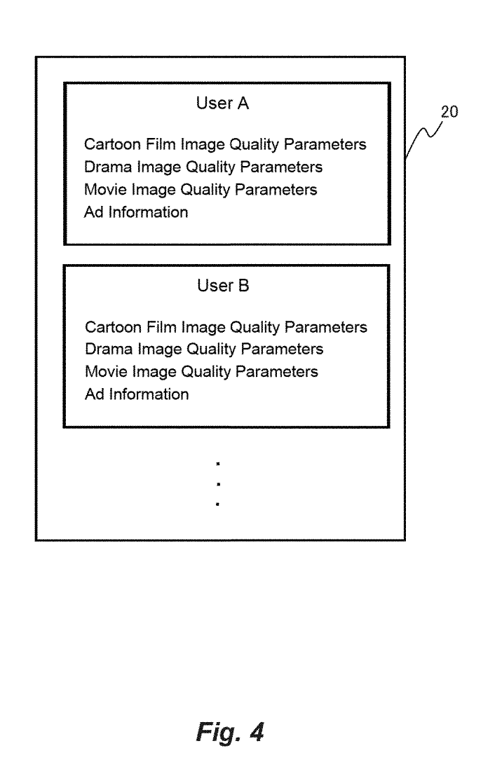

The user information registered by a user is stored in the cloud server 20 in association to that individual user. The image quality information, which is part of the user information, is stored as image quality parameters for adjusting the image quality of videos. Therefore, the cloud server 20 stores image quality parameters for each video type, such as cartoon film image quality parameters, drama image quality parameters, and movie image quality parameters, for each user (see FIG. 4).

The cloud server 20 further contains ad information for delivering ads to the display device 10 (see FIG. 4). This ad information is tailored for each individual user on the basis of, for example, his/her user attribute information. For example, if the user attribute information indicates that the user is a female aged from 20 to 29, her ad information includes cosmetics ads targeted at women in their 20's. As another example, the ad information may include ads related to his/her hobbies indicated by hobby information which is part of the user attribute information.

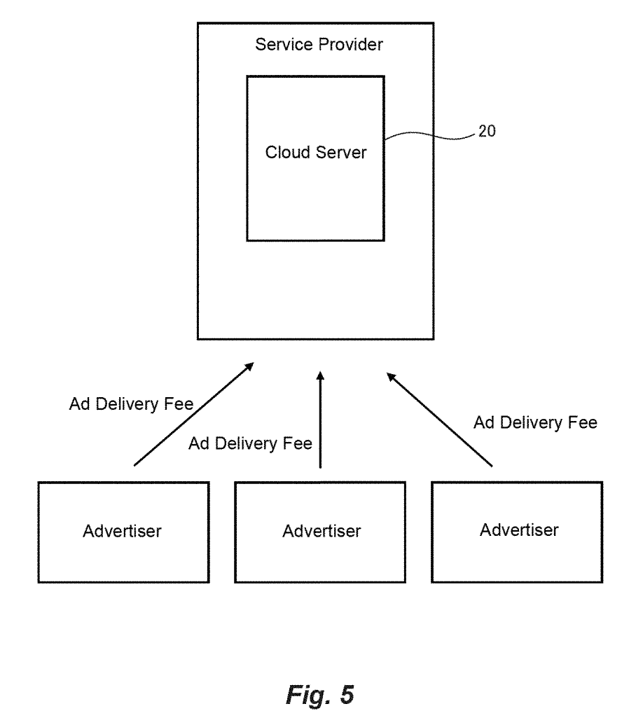

The cloud server 20 is owned by a service provider that provides the automatic image quality adjustment service (see FIG. 5). The service provider signs a contract with advertisers on ad delivery and receives ad delivery fees. The ad information provided by advertisers is, as mentioned earlier, stored in the cloud server 20 so that it can be delivered to particular users on the basis of user attribute information. Alternatively, the ad information may be stored in the cloud server 20 so that it can be delivered not to particular users, but to all users. The service provider may prepare its own ad information and store it in the cloud server 20.

Now referring back to the flow chart in FIG. 2, in step S30, the timing controller 14 or the SoC 13 determines whether or not the user has agreed to the terms of service and registered his/her user information. Upon determining that the user has now agreed to the terms of service and registered his/her user information, the process proceeds to step S40. Upon determining otherwise, the process described in the flow chart is terminated because the user is not going to use the automatic image quality adjustment service. Since the user is allowed to choose not to use the automatic image quality adjustment service as mentioned earlier, if the timing controller 14 or the SoC 13 determines that the user is not going to use the automatic image quality adjustment service, it does not prompt the user to agree to the terms of service and register his/her user information.

In step S40, the timing controller 14 or the SoC 13 transmits information indicating the type of the program selected by the user to the cloud server 20 over the Internet. Specifically, the timing controller 14 or the SoC 13 extracts information indicating the type of the program selected by the user, such as program category codes or program feature codes, from an EPG (electronic program guide) and transmits the extracted information to the cloud server 20. The information indicating the type of program may include user-identifying information.

The cloud server 20 identifies the user from incoming information and then extracts image quality parameters for each type of program from the user information of that user on the basis of the information indicating a type of program in order to transmit the parameters to the display device 10. For example, if the information indicating a type of program, received from the display device 10 owned by a user A, indicates cartoon films, the cloud server 20 extracts cartoon film image quality parameters from the user information of the user A for transmission to the display device 10 of the user A.

The cloud server 20 also transmits the ad information included in the user information to the display device 10 either simultaneously with or after the transmission of the image quality parameters.

In step S50, the timing controller 14 or the SoC 13 receives the image quality parameters and ad information from the cloud server 20. The received ad information is stored as the video signal B in the flash RAM 15.

In step S60, the timing controller 14 or the SoC 13 generates the video signal A representing an image quality-adjusted video by using the image quality parameters received from the cloud server 20. The timing controller 14 or the SoC 13 transmits the video signal A to the timing controller 14, and the timing controller 14 supplies the video signal A as the video signal C to the liquid crystal module 16. The liquid crystal panel 18 hence displays an image quality-adjusted video.

The video display system 100 may be structured such that it allows the user, viewing an image quality-adjusted video, to further modify image quality. More specifically, the video display system 100 may be structured such that it allows the user to select “More vivid colors” or “More natural colors” to further alter image quality by operating the remote control 31. In this structure, the timing controller 14 or the SoC 13 transmits adjusted image quality parameters as the new image quality parameters for the type of program to the cloud server 20. The cloud server 20 stores the received new image quality parameters by substituting the new image quality parameters for the image quality parameters previously stored for the type of program.

The same procedures are followed when the liquid crystal panel 18 displays a program recorded in the recorder 30. More specifically, the timing controller 14 or the SoC 13 obtains from the recorder 30 information indicating the type of program to be reproduced and transmits the information to the cloud server 20 over the Internet. The cloud server 20 identifies the user on the basis of incoming information and then extracts image quality parameters for that type of program from the user information of the user on the basis of the information indicating the type of program in order to transmit the parameters to the display device 10. The timing controller 14 or the SoC 13 generates the video signal A representing an image quality-adjusted video by using the image quality parameters received from the cloud server 20.

More practically, the video display system 100 may be structured in such a manner as to retain the image quality parameters received from the cloud server 20 and turn on the parameters upon access to the cloud server 20. In this structure, both the cloud server 20 and the video display system 100 record the image quality parameters for each type of program.

Next will be described a process performed when the result of the determination made in step S10 of the flow chart in FIG. 2 is affirmative. If the user has previously agreed to the terms of service and registered his/her user information as described above, the determination in step S10 is affirmative, and the process proceeds to step S20.

In step S20, the timing controller 14 supplies the video signal B (ad information) contained in the flash RAM 15 as the video signal C to the liquid crystal module 16 until the timing controller 14 receives the video signal A from the SoC 13 (or if it is the timing controller 14 that generates the video signal A, until the video signal A is generated).

Generally, liquid crystal televisions and like display devices, when their power supply is turned on, do not start displaying a video (program) immediately and take some time to do so. These display devices similarly need some time to display a program video recorded in the recorder 30 when the power supply for the recorder 30 is turned on.

In the video display system of the present embodiment, an advertisement is displayed on the liquid crystal panel 18 upon activation of the display device 10 or the recorder 30 (i.e., upon turning on their power supply) until a video is displayed for viewing by a user who has agreed to the terms of service to use the automatic image quality adjustment service.

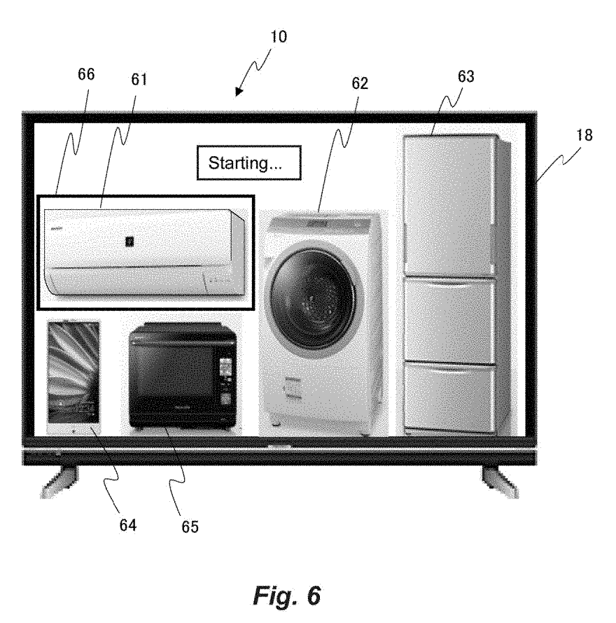

FIG. 6 is an illustration of an example advertisement displayed in response to activation of the display device 10 until a program is displayed. The example shown in FIG. 6 includes a display of a text message, “Starting . . . ,” and images of home electrical appliances 61 to 65. The user can recognize from the displayed text message, “Starting . . . ,” that the display device 10 is in the process of starting.

The user can get more detailed information on these home electrical appliances 61 to 65 by operating the remote control 31. More specifically, the liquid crystal panel 18 displays a highlight frame 66 together with the home electrical appliances 61 to 65. The user can move the highlight frame 66 and select any of the home electrical appliances to get detailed information on that appliance, by operating arrow buttons 32 (see FIG. 3) on the remote control 31. FIG. 6 shows the home electrical appliance 61 being selected using the highlight frame 66. When the user presses a pre-designated button (e.g., an Enter button 33) on the remote control 31 with this highlighting, the liquid crystal panel 18 displays detailed information on the home electrical appliance being selected using the highlight frame 66.

The detailed information on the home electrical appliances is obtained from the home pages for the home electrical appliances over the Internet, so that the liquid crystal panel 18 can display it. More specifically, in response to a press of a pre-designated button on the remote control 31, the timing controller 14 or the SoC 13 accesses the home page where detailed information is given on the home electrical appliance being selected using the highlight frame 66, so that the liquid crystal panel 18 can display data collected from the home page. For example, the timing controller 14 or the SoC 13 can readily access the home page for the selected home electrical appliance if ad information contains home page address information for each home electrical appliance.

Image quality is preferably adjustable at any timing by the user operating the remote control 31. The ad information stored in the flash RAM 15 is updated in a suitable manner. For example, when the user switches to view a different type of program, the timing controller 14 or the SoC 13 transmits information indicating that type of program to the cloud server 20. The cloud server 20 transmits to the display device 10 the image quality parameters for the type of program on the basis of the received information indicating the type of program and additionally transmits new ad information to the display device 10. The cloud server 20 hence updates the stored ad information in a suitable manner.

### Second Embodiment

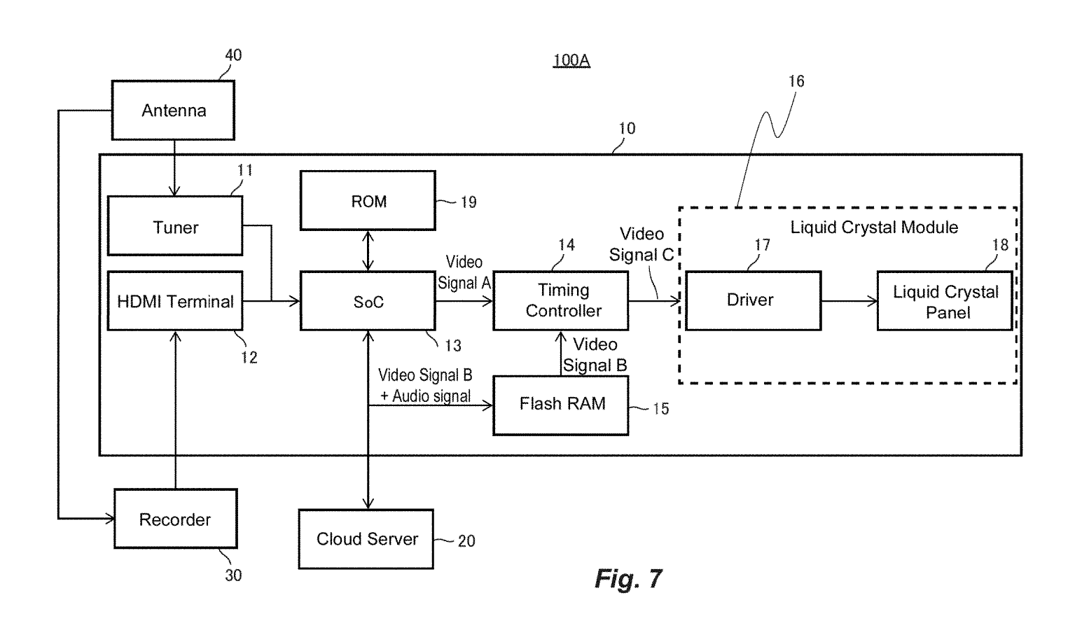

FIG. 7 is a block diagram of a configuration of a video display system 100A in accordance with a second embodiment. The present embodiment provides automatic image quality adjustment service similarly to the first embodiment. The video display system 100A of the second embodiment differs from the video display system 100 of the first embodiment in the ad information delivery process.

In the video display system 100A of the second embodiment, the display device 10 displays advertisements based on user attribute information in a part of a time slot assigned for broadcasting of advertisements (commercials) in a television program. For this purpose, the flash RAM 15 contains ad information as the video signal B on the basis of user attribute information and further contains an audio signal associated with the ad information. The cloud server 20 contains ad information and an audio signal associated with the ad information on the basis of the user attribute information, and when transmitting video-type-specific image quality parameters to the display device 10, transmits the ad information and the audio signal associated with the ad information simultaneously.

In the broadcast of advertisements in a television program, the timing controller 14 or the SoC 13 retrieves the video signal B and the audio signal from the flash RAM 15 and outputs the signals to the liquid crystal module 16 via the timing controller 14. The timing controller 14 or the SoC 13 controls such that the ad information retrieved from the flash RAM 15 is displayed in a time slot for broadcasting of an ad of the same advertiser as the ad information contained in the flash RAM 15. For example, the advertisements broadcast in a television program may include those of multiple advertisers: Company J, Company K, and Company L. If the flash RAM 15 contains ad information of Company K, the video display system 100A displays that ad information of Company K stored in the flash RAM 15 during the television broadcasting of an advertisement of Company K.

The ad information contained in the flash RAM 15 may be displayed, for example, at timings determined based on a predetermined ad broadcasting schedule. For example, if an advertisement of Company K is scheduled to be broadcast at a predetermined time in a television program that is being viewed by a viewer, the video display system 100A displays Company K's ad information stored in the flash RAM 15 at the predetermined time.

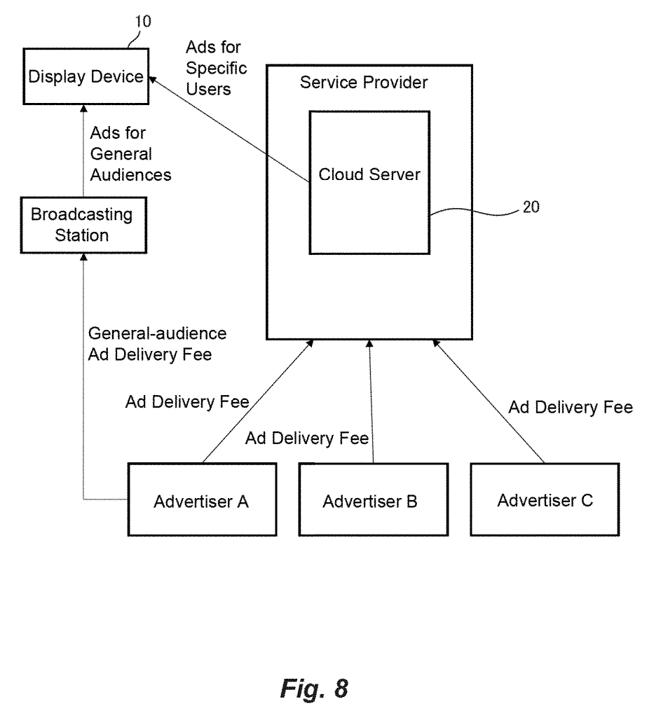

FIG. 8 is a diagram showing the types of ad information displayed on the display device 10 and the flow of ad delivery fees in accordance with the present embodiment. Multiple advertisers sign a contract with a broadcasting station to have broadcast their advertisements aimed at general audiences (television commercials) and accordingly pay general-audience ad delivery fees to the broadcasting station. The advertisers sign another contract with a service provider that provides automatic image quality adjustment service to have delivered their advertisements tailored for specific users based on user attribute information and accordingly pay ad delivery fees to the service provider.

The display device 10 displays advertisements aimed at general audiences (television commercials) in a television program and as mentioned earlier, also displays advertisements tailored for specific users based on user attribute information and transmitted from the cloud server 20.

In the present embodiment, the display device 10 displays ad information of an advertiser on the basis of user attribute information of each user in an ad broadcasting time slot that that same advertiser purchased in advance from a broadcasting station. Both the broadcasting station and the advertiser would therefore benefit from the video display system 100A. In addition, the display device 10 displays ad information based on user attribute information in a time slot for broadcasting of television commercials. The user would therefore comfortably view the ad information.

The flash RAM 15 inevitably contains the video signal B and audio signal for each advertiser and for this reason needs to have a greater memory capacity than in the first embodiment. However, the ad information, prepared based on user attribute information, is viewed more often than in the first embodiment, and the service provider providing the automatic image quality adjustment service receives more ad delivery fees accordingly. Therefore, the flash RAM 15 may be more costly, but this extra cost can be balanced out by the increased ad delivery fees. The display device 10 does not need to be sold at an increased price.

### Third Embodiment

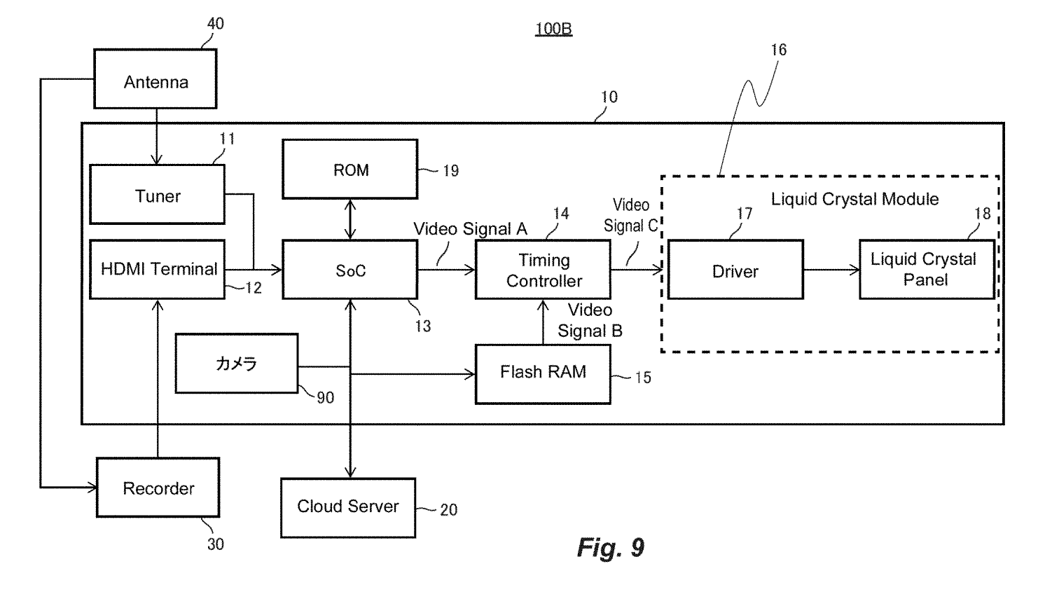

FIG. 9 is a block diagram of a configuration of a video display system 100B in accordance with a third embodiment. The video display system 100B of the third embodiment additionally includes a camera 90 on the display device 10 when compared with the video display system 100 of the first embodiment.

In the present embodiment, the video display system 100B collects information as to whether or not the user is viewing ads when the ads are broadcast in a television program. This information is sold to, for example, advertisers and information search companies.

The cloud server 20 does not deliver ad information to the display device 10 in the present embodiment. Alternatively, the cloud server 20 may deliver ad information to the display device 10 as in the first and second embodiments.

The camera 90 is disposed, for example, on the top center of the liquid crystal panel 18 for capturing an image of objects before the display device 10. The images captured by the camera 90 are fed to the timing controller 14 or the SoC 13.

The timing controller 14 or the SoC 13 carries out a face recognition process on the images captured by the camera 90 to determine whether or not there are human faces in the images. In other words, the timing controller 14 or the SoC 13 functions further as an image processing unit. The face recognition is carried out based on a known method. The information as to whether or not there are human faces in the images, as well as times at which the images are captured and information about the program being viewed, is fed from the timing controller 14 or the SoC 13 to the cloud server 20. The advertisement being broadcast when the camera 90 captures an image can be identified from the time at which the image is captured and the information about the program being viewed at that time. Therefore, it is possible to determine whether or not the user has viewed ad broadcasting, from the results of the face recognition.

The service provider providing the automatic image quality adjustment service supplies the information as to whether or not the user has viewed ad broadcasting to the advertisers and information search companies with which the service provider has a contract and receives information fees in return.

The face recognition process may not only determine whether there are human faces in an image, but also determine whether persons in the image are looking toward the display device 10. Determining whether a person in an image is looking toward the display device 10 enables more precise determination as to whether or not the user is viewing ad broadcasting.

The information as to whether the user is viewing ad broadcasting may be described as information as to what advertisements are being viewed by the user. The service provider may sell to advertisers and information search companies this information on what television commercials are viewed, for example, in each program and during each time period by users.

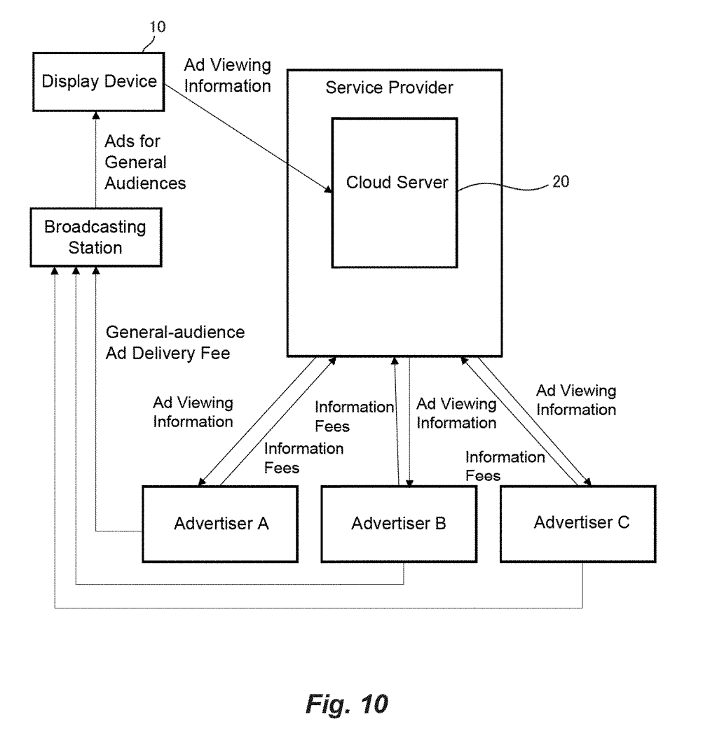

FIG. 10 is a diagram showing the flow of, for example, ad viewing information, ad delivery fees, and information fees in accordance with the present embodiment. Multiple advertisers sign a contract with a broadcasting station to have broadcast their advertisements aimed at general audiences (television commercials) and accordingly pay general-audience ad delivery fees to the broadcasting station. The advertisers sign another contract with a service provider that provides automatic image quality adjustment service to receive ad viewing information as to whether or not users view ad broadcasting, receive ad viewing information from the service provider, and pay information fees.

FIG. 10 shows the service provider sending ad viewing information to advertisers and receiving information fees. Alternatively, the service provider may send ad viewing information to an information search company and receive information fees.

In the present embodiment, the service provider can sell information as to which advertisements are viewed by users to advertisers and information search companies. The present embodiment hence balances out the expenses for the additional camera 90 and the face recognition software. The display device 10 does not need to be sold at an increased price.

The face recognition process may be carried out by the cloud server 20, not by the display device 10.

The camera 90 may be used for purposes other than to know whether or not users are viewing advertisements. For example, the camera 90 may be used to keep an eye on children or pets while the caregiver is out. For this purpose, for example, the images captured by the camera 90 are stored in the cloud server 20. The user can access the cloud server 20 from, for example, his/her smartphone to view the images captured by the camera 90 when he/she is outside.

The embodiments disclosed above are for illustrative purposes only and provide no basis for restrictive interpretations of the present invention. The embodiments may be modified, without departing from the scope of the present invention.

For example, the ad information stored in the flash RAM 15 may be displayed not only upon activation of the display device 10 or the recorder 30 until a video is displayed. The ad information stored in the flash RAM 15 may be displayed, for example, when the user switches programs (channels), switches programs to and from terrestrial wave, BS, CS, and cable television broadcasting, or switches between a television program and a recorded program.

Ad information may be stored in the flash RAM 15 based on program viewing history. The display device 10 sends information on types of programs to the cloud server 20, so that the cloud server 20 can record information on the types of programs viewed by each user as viewing history information. Ad information may be stored for each user based on this viewing history information for transmission to the display device 10. For example, ad information of tour companies may be displayed on the display device 10 for a user who often watches travel programs.

The display device 10 may be connected to a DVD player, a BD (Blu-ray disc) player, or another like external drive, so that the ad information stored in the flash RAM 15 can be displayed upon activation of the DVD player, the BD player, or the like until a video is displayed from a DVD, a BD, or a like storage medium.

The embodiments disclosed above adjust image quality in accordance with the types of television broadcast programs. Alternatively, image quality of a playback from a DVD, a BD, or a like storage medium may be adjusted in accordance with the type of video played back from the medium. For this purpose, the timing controller 14 or the SoC 13 obtains information on the type of video played back from a DVD, a BD, or a like storage medium and transmits the information to the cloud server 20 over the Internet. The cloud server 20, based on the information on the video type, extracts corresponding video-type-specific image quality parameters from the user information of the user and transmits the parameters to the display device 10. The timing controller 14 or the SoC 13 adjusts the image quality of the video played back from the DVD, BD, or like storage medium based on the image quality parameters received from the cloud server 20. Alternatively, it may be the cloud server 20, instead of the timing controller 14 or the SoC 13, that obtains the information on the type of video played back from the DVD, BD, or like storage medium.

### REFERENCE SIGNS LIST

10 Display Device
13 SoC
14 Timing Controller
15 Flash RAM
17 Driver
18 Liquid Crystal Panel
20 Cloud Server
30 Recorder
31 Remote Control
100, 100A, 100B Video Display System

1. A video display system comprising:
a display device configured to display a video; and
a server installed external to the display device,
wherein
the display device comprises:
an input circuitry which enables a user to input desirable image quality information for each type of video;
a video type obtaining circuitry which obtains information related to a type of a video to be displayed;
a transmission circuitry which transmits the image quality information inputted through the input circuitry to the server and also transmits, to the server, the information obtained by the video type obtaining circuitry in relation to the type of the video to be displayed;
an image quality information obtaining circuitry which obtains, from the server, image quality information in accordance with the type of the video to be displayed; and
an image quality adjusting circuitry which adjusts image quality of the video to be displayed based on the image quality information obtained by the image quality information obtaining circuitry, and
the server stores the inputted image quality information and the obtained information in relation to the type of the video to be displayed which are transmitted from the transmission circuitry, as the image quality information for each type of video for each user.

2. The video display system according to claim 1, wherein:
the display device further comprises a display control circuitry which causes a display screen to be displayed on which the user is asked whether or not the user agrees to use image quality adjustment service by which image quality of a video is adjusted in accordance with a type of the video and to have ad information displayed; and
the display control circuitry causes the ad information to be displayed if the user has agreed to use the image quality adjustment service and to have the ad information displayed.

3. The video display system according to claim 2, wherein:
the display control circuitry, if the user has agreed to use the image quality adjustment service, causes a screen to be displayed on which the user can input user attribute information;
the transmission circuitry, if the user has inputted user attribute information through the input circuitry, transmits the user attribute information to the server;
the server stores ad information of each user in accordance with the user attribute information transmitted from the transmission circuitry; and
the display control circuitry obtains ad information in accordance with the user attribute information from the server and causes the ad information to be displayed upon activation of the display device until a video is displayed, upon activation of the display device until a video fed from an external device connected to the display device is displayed, and/or during switching of videos to be displayed.

4. The video display system according to claim 3, wherein the display control circuitry obtains ad information of an advertiser from the server in accordance with the user attribute information and causes the ad information obtained from the server to be displayed in a part of an ad broadcasting time slot for that same advertiser in a television program.

5. The video display system according to claim 1, wherein the display device further comprises:
a camera which captures an image of an object before the display device; and
an image processing circuitry which performs a face recognition process on the image captured by the camera, so as to obtain information as to whether or not the user is viewing ad broadcasting.

6. A video display system comprising:
a display device configured to display a video; and
a server installed external to the display device,
wherein
the display device comprises:
circuitry; and
a memory connected with the circuitry; wherein
the circuitry enables a user to input desirable image quality information for each type of video,
the circuitry obtains information related to a type of a video to be displayed,
the circuitry transmits the inputted image quality information to the server, and also transmits, to the server, the obtained information related to the type of the video to be displayed,
the circuitry obtains, from the server, image quality information in accordance with the type of the video to be displayed,
the circuitry adjusts image quality of the video to be displayed based on the image quality information obtained from the server, and
the server stores the inputted image quality information and the obtained information in relation to the type of the video to be displayed which are transmitted from the circuitry, as the image quality information for each type of video for each user.

7. The video display system according to claim 6, wherein:
the circuitry causes a display screen to be displayed on which the user is asked whether or not the user agrees to use image quality adjustment service by which image quality of a video is adjusted in accordance with a type of the video and to have ad information displayed; and
the circuitry causes the ad information to be displayed if the user has agreed to use the image quality adjustment service and to have the ad information displayed.

8. The video display system according to claim 7, wherein:
the circuitry, if the user has agreed to use the image quality adjustment service, causes a screen to be displayed on which the user can input user attribute information;
the circuitry, if the user has inputted user attribute information, transmits the user attribute information to the server;
the server stores ad information of each user in accordance with the user attribute information transmitted from the circuitry; and
the circuitry obtains ad information in accordance with the user attribute information from the server and causes the ad information to be displayed upon activation of the display device until a video is displayed, upon activation of the display device until a video fed from an external device connected to the display device is displayed, and/or during switching of videos to be displayed.

9. The video display system according to claim 8, wherein the circuitry obtains ad information of an advertiser from the server in accordance with the user attribute information and causes the ad information obtained from the server to be displayed in a part of an ad broadcasting time slot for that same advertiser in a television program.

10. The video display system according to claim 6, wherein
the display device further comprises a camera which captures an image of an object before the display device; and
the circuitry performs a face recognition process on the image captured by the camera, so as to obtain information as to whether or not the user is viewing ad broadcasting.

11. A method of controlling a video display system comprising: a display device configured to display a video; and a server installed external to the display device,
the method comprising:
enabling a user to input desirable image quality information for each type of video;
obtaining information related to a type of a video to be displayed;
transmitting the inputted image quality information to the server, and also transmitting, to the server, the obtained information related to the type of the video to be displayed;
obtaining, from the server, image quality information in accordance with the type of the video to be displayed;
adjusting image quality of the video to be displayed based on the image quality information obtained from the server; and
storing, to the server, the inputted image quality information and the obtained information in relation to the type of the video to be displayed which are transmitted to the server, as the image quality information for each type of video for each user.

12. The method of controlling the video display system according to claim 11, further comprising:
displaying a display screen on which the user is asked whether or not the user agrees to use image quality adjustment service by which image quality of a video is adjusted in accordance with a type of the video and to have ad information displayed; and
displaying the ad information if the user has agreed to use the image quality adjustment service and to have the ad information displayed.

13. The method of controlling the video display system according to claim 12, further comprising:
if the user has agreed to use the image quality adjustment service, displaying a screen on which the user can input user attribute information;
if the user has inputted user attribute information, transmitting the user attribute information to the server;
storing, to the server, ad information of each user in accordance with the transmitted user attribute information;
obtaining ad information in accordance with the user attribute information from the server; and
displaying the ad information upon activation of the display device until a video is displayed, upon activation of the display device until a video fed from an external device connected to the display device is displayed, and/or during switching of videos to be displayed.

14. The method of controlling the video display system according to claim 13, further comprising:
obtaining ad information of an advertiser from the server in accordance with the user attribute information; and
displaying the ad information obtained from the server in a part of an ad broadcasting time slot for that same advertiser in a television program.

15. The method of controlling the video display system according to claim 11, wherein
the display device further comprises a camera which captures an image of an object before the display device, and
the method further comprises performing a face recognition process on the image captured by the camera, so as to obtain information as to whether or not the user is viewing ad broadcasting.
